(19) United States
(12) Patent Application Publication
(10) Pub. No.: US 2023/0134155 A1
(43) Pub. Date: May 4, 2023

(54) DRIVE APPARATUS

(71) Applicant: NIDEC CORPORATION, Kyoto (JP)

(72) Inventors: Hironobu KUMAGAI, Kyoto (JP); Keisuke NAKATA, Kyoto (JP)

(21) Appl. No.: 17/974,522

(22) Filed: Oct. 27, 2022

(30) Foreign Application Priority Data
Oct. 29, 2021 (JP) 2021-178103

(51) Int. Cl. H02K 1/20; H02K 5/22

(52) U.S. Cl. CPC H02K 1/20; H02K 5/225

(57) ABSTRACT

One aspect of a drive apparatus of the present invention includes: a rotor having a shaft that rotates about a central axis; a stator disposed radially outside the rotor; a bus bar unit having a plurality of bus bars connected to the stator and a bus bar holder supporting the bus bars; a fluid feed portion disposed radially outside the stator and provided with a feed hole for feeding a fluid to the stator; and a housing that accommodates the rotor, the stator, the bus bar unit, and the fluid feed portion. The bus bar unit extends along the circumferential direction along the outer periphery of the stator and has an opening portion that opens toward the stator.

### CROSS-REFERENCE TO RELATED APPLICATIONS

The present invention claims priority under 35 U.S.C. § 119 to Japanese Patent Application No. 2021-178103 filed on Oct. 29, 2021, the entire content of which is incorporated herein by reference.

### FIELD OF THE INVENTION

The present invention relates to a drive apparatus.

### Background

In recent years, the development of drive apparatuses to be mounted on electric vehicles has been actively carried out. Such a drive apparatus is equipped with a cooling structure for cooling a stator of a rotating electrical machine. There is a conventional structure in which oil flowing out from a catch tank is guided by an oil guide portion of a bus bar and drips onto a rotary electric machine.

In the motor, since the heat generation amount of the coil is the largest, efficient cooling can be performed by feeding the fluid to the coil end where the coil is exposed. On the other hand, since the bus bar of the conventional structure extends along the axial direction of the motor, when the fluid is guided from the bus bar to the coil end, there is a problem that it is difficult to feed the fluid to the entire coil end and the cooling efficiency is poor.

### SUMMARY

One aspect of an exemplary drive apparatus of the present invention includes: a rotor having a shaft that rotates about a central axis; a stator disposed radially outside the rotor; a bus bar unit having a plurality of bus bars connected to the stator and a bus bar holder supporting the bus bars; a fluid feed portion disposed radially outside the stator and provided with a feed hole for supplying a fluid to the stator; and a housing that accommodates the rotor, the stator, the bus bar unit, and the fluid feed portion. The bus bar unit extends along the circumferential direction along the outer periphery of the stator and has an opening portion that opens toward the stator.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic cross-sectional view of a drive apparatus according to an embodiment;

FIG. 2 is a perspective view of a stator according to an embodiment;

FIG. 3 is a schematic view illustrating a circuit of a winding portion according to an embodiment;

FIG. 4 is a perspective view of a bus bar unit according to an embodiment;

FIG. 5 is a perspective view of a neutral point bus bar and a plurality of phase bus bars according to an embodiment;

FIG. 6 is a cross-sectional view of a fluid feed portion, a bus bar unit, and a stator according to an embodiment;

FIG. 7 is a schematic cross-sectional view of the vicinity of an opening portion of a bus bar unit according to Modification 1;

FIG. 8 is a schematic cross-sectional view of the vicinity of an opening portion of a bus bar unit according to Modification 2;

FIG. 9 is a schematic cross-sectional view of the vicinity of an opening portion of a bus bar unit according to Modification 3;

FIG. 10 is a schematic cross-sectional view of the vicinity of an opening portion of a bus bar unit of Modification 4; and

FIG. 11 is a schematic cross-sectional view of the vicinity of an opening portion of a bus bar unit of Modification 5.

### DETAILED DESCRIPTION

Hereinafter, an embodiment of a drive apparatus 1 will be described with reference to the drawings. In the drawings, an XYZ coordinate system is illustrated appropriately as a three-dimensional orthogonal coordinate system. A Z-axis direction appropriately illustrated in each drawing is an up-down direction in which a positive side is an “upper side” and a negative side is a “lower side”. The central axis J appropriately illustrated in each drawing is parallel to the Y-axis direction. In the following description, the axial direction of the central axis J may be simply referred to as “axial direction”, the +Y side may be referred to as “one side in the axial direction”, and the −Y side may be referred to as “the other side in the axial direction”. A radial direction centered on the central axis J is simply referred to as a “radial direction” in some cases. Further, in some cases, the circumferential direction centered on the central axis J is simply referred to as the “circumferential direction”, a counterclockwise direction when viewed from the +Y side is referred to as “one side θ1 in the circumferential direction”, and a clockwise direction when viewed from the +Y side is referred to as “the other side θ2 in the circumferential direction”.

The up-down direction, the upper side, and the lower side are merely names for describing an arrangement relationship between the respective units, and an actual arrangement relationship and the like may be other than the arrangement relationship indicated by these names. Furthermore, the directions described as one side in the axial direction and the other side in the axial direction can reproduce an effect of the embodiment even when being replaced with each other. Similarly, the directions described as the one side θ1 in the circumferential direction and the other side θ2 in the circumferential direction can reproduce the effect of the embodiment even when being replaced with each other.

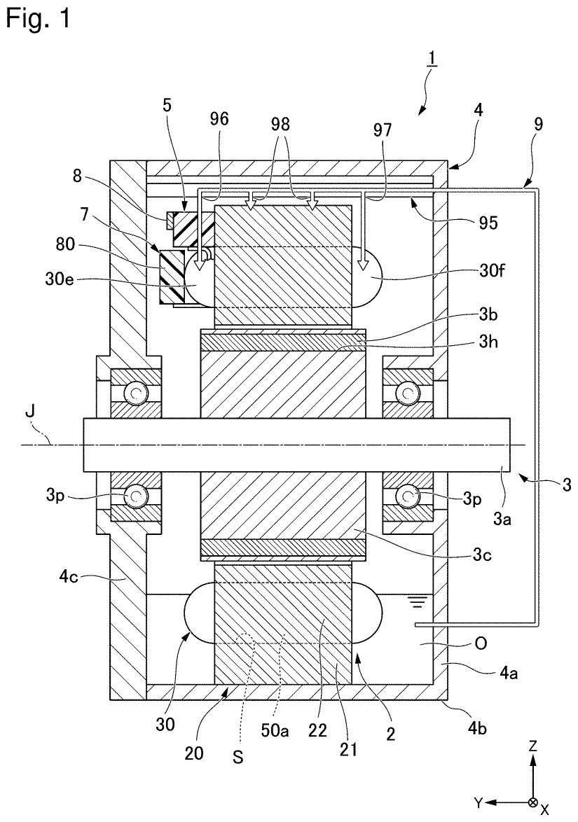

FIG. 1 is a schematic cross-sectional view of a drive apparatus 1 according to the present embodiment.

The drive apparatus 1 of the present embodiment is an inner rotor type motor. The drive apparatus 1 of the present embodiment is a three-phase AC motor. The drive apparatus 1 has both a function as a motor and a function as a generator. The center of the drive apparatus 1 is the central axis J.

The drive apparatus 1 includes a rotor 3, a stator 2, a bus bar unit 5, a connection bus bar unit 7, a temperature sensor 8, a fluid feed portion 95, a housing 4, and a fluid O accumulated inside the housing 4.

The housing 4 accommodates the rotor 3, the stator 2, the bus bar unit 5, the connection bus bar unit 7, and the fluid feed portion 95. The fluid O is accumulated in a lower region inside the housing 4. A flow path 9 is connected to the housing 4, and transfers the fluid O to the fluid feed portion 95 disposed in an upper region of the housing 4.

The housing 4 includes a cylindrical portion 4b having a bottom plate portion 4a, and a bearing holder 4c that covers an opening of the cylindrical portion 4b. The cylindrical portion 4b has a cylindrical shape centered on the central axis J. The cylindrical portion 4b surrounds the stator 2 from the radially outer side. The bottom plate portion 4a is located on the other side (−Y side) in the axial direction of the stator 2. On the other hand, the bearing holder 4c is located on one side (+Y side) in the axial direction of the stator 2. The bearing holder 4c and the bottom plate portion 4a hold the bearing 3p.

The rotor 3 is rotatable about the central axis J. The rotor 3 is disposed radially inward of the stator 2 having an annular shape. That is, the rotor 3 opposes the stator 2 in the radial direction. The rotor 3 includes a shaft 3a, a rotor magnet 3b, and a rotor core 3c.

The shaft 3a extends in the axial direction along the central axis J. The shaft 3a has a columnar shape that is centered on the central axis J and extends in the axial direction. The shaft 3a rotates about the central axis J. The shaft 3a is rotatably supported by two bearings 3p.

The rotor core 3c is formed by laminating magnetic steel plates. The rotor core 3c has a tubular shape extending in the axial direction. An inner peripheral surface of the rotor core 3c is fixed to an outer peripheral surface of the shaft 3a. The rotor core 3c has a holding hole 3h into which the rotor magnet 3b is inserted and fixed.

The rotor magnet 3b faces the stator 2 in the radial direction. The rotor magnet 3b is held in a state of being embedded in the rotor core 3c. The rotor magnet 3b of the present embodiment has eight poles. The number of poles of the rotor 3 is not limited to that in the present embodiment. The rotor magnet 3b may be a magnet of another form such as an annular ring magnet.

The stator 2 faces the rotor 3 in the radial direction with a gap interposed therebetween. In the present embodiment, the stator 2 is disposed radially outward of the rotor 3. The stator 2 includes a stator core 20 and a winding portion 30 attached to the stator core 20.

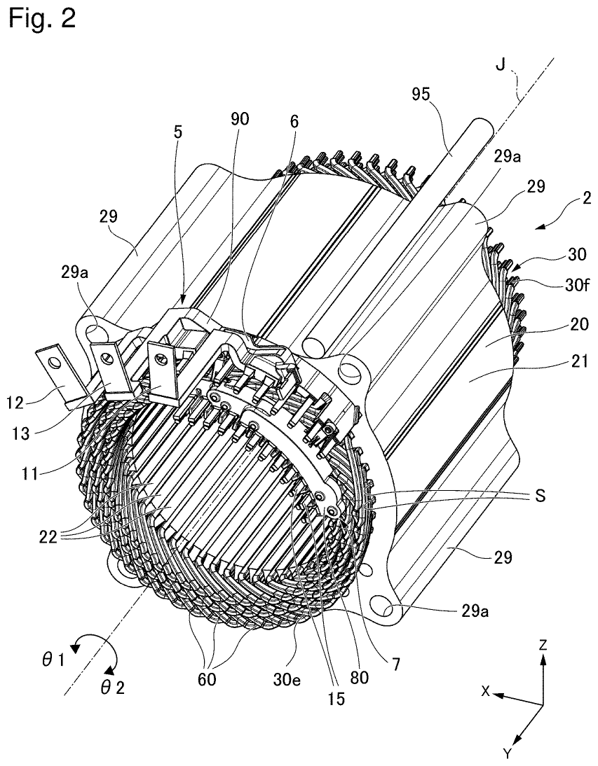

FIG. 2 is a perspective view of the stator 2 of the present embodiment.

The stator core 20 has an annular shape centered on the central axis J. The stator core 20 consists of electromagnetic steel sheets stacked along the axial direction. The stator core 20 includes a core back 21 having a cylindrical shape centered on the central axis J and a plurality of teeth 22 extending radially inward from the core back 21.

The plurality of teeth 22 are arranged at regular intervals in the circumferential direction. The winding portion 30 is mounted on the teeth 22. A slot S is provided between the teeth 22 adjacent to each other in the circumferential direction. A plurality of conductors of the winding portion 30 passes through the slot S. In the slot S, an insulating paper (not illustrated) is interposed between the winding portion 30 and the stator core 20.

The core back 21 includes a plurality of fixing portions 29 protruding radially outward from the outer peripheral surface. The fixing portion 29 is fixed to the inner surface of the housing 4. That is, the stator 2 is fixed to the housing 4 at the fixing portion 29. A plurality of the fixing portions 29 are provided at intervals in the circumferential direction. The number of fixing portions 29 is, for example, four. The four fixing portions 29 are disposed at regular intervals over the entire circumference in the circumferential direction.

In the present embodiment, the fixing portion 29 extends in the axial direction over the entire length of the stator core 20. The fixing portion 29 is provided with an insertion hole 29a axially penetrating the fixing portion 29. A bolt (not illustrated) extending in the axial direction passes through the insertion hole 29a. The bolt passes through the insertion hole 29a and is tightened into a screw hole (not illustrated) provided in the inner surface of the housing 4. The fixing portion 29 is fixed to the housing 4 by fastening the bolt into the screw hole.

The winding portion 30 includes a first coil end 30e protruding to one side (+Y side) in the axial direction of the stator core 20 and a second coil end 30f protruding to the other side (−Y side) in the axial direction of the stator core 20.

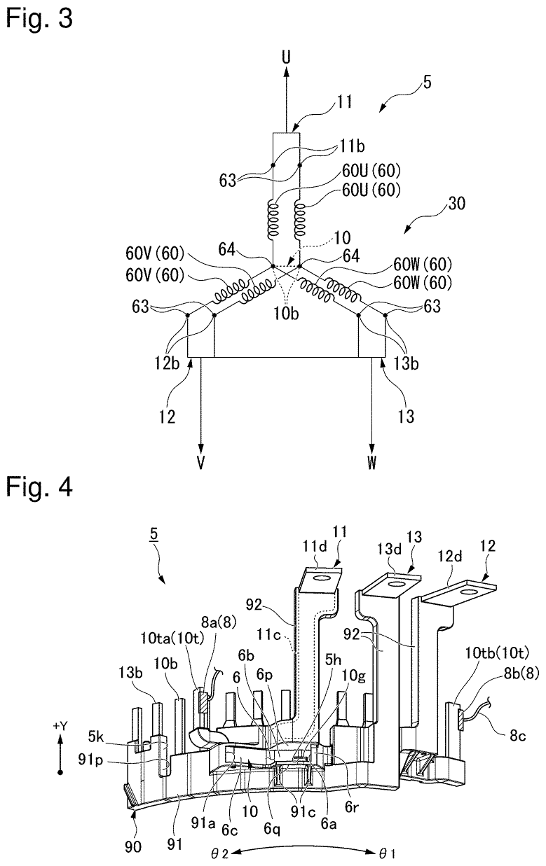

FIG. 3 is a schematic view illustrating a circuit of the winding portion 30 of the present embodiment.

The winding portion 30 of the present embodiment includes two U-phase coil portions 60U, two V-phase coil portions 60V, and two W-phase coil portions 60W. In the following description, when the U-phase coil portion 60U, the V-phase coil portion 60V, and the W-phase coil portion 60W are not distinguished, they are simply referred to as a coil portion 60.

The bus bar unit 5 of the present embodiment includes three phase bus bars 11, 12, and 13 and one neutral point bus bar 10. The three phase bus bars 11, 12, and 13 are classified into a U-phase bus bar 11, a V-phase bus bar 12, and a W-phase bus bar 13.

The U-phase coil portion 60U, the V-phase coil portion 60V, and the W-phase coil portion 60W are Y-connected by the neutral point bus bar 10 and the phase bus bars 11, 12, and 13. In the present embodiment, two Y connections corresponding to the two coil portions 60 of each phase are configured, and the respective Y connections are connected in parallel. That is, the winding portion 30 is configured with the two Y-connections by the bus bar unit 5.

The coil portion 60 has a first end 63 and a second end 64. The first end 63 and the second end 64 are provided at one end and the other end of the coil portion 60, respectively. The coil portion 60 is attached to the stator core 20 between the first end 63 and the second end 64 to constitute a coil of each phase. The coil portion 60 is connected to the bus bar unit 5 in the first end 63 and the second end 64.

The second ends 64 of the two U-phase coil portions 60U, the two V-phase coil portions 60V, and the two W-phase coil portions 60W are connected to one neutral point bus bar 10. As a result, the second ends 64 of the six coil portions 60 have the same potential and form a neutral point. That is, the neutral point bus bar 10 forms the neutral point of the three-phase circuit.

The first ends 63 of the two U-phase coil portions 60U are connected to the U-phase bus bar 11. The first ends 63 of the two V-phase coil portions 60V are connected to the V-phase bus bar 12. The first ends 63 of the two W-phase coil portions 60W are connected to the W-phase bus bar 13. Alternating currents having phases shifted from each other by 120° are caused to flow through the phase bus bars 11, 12, and 13.

The coil portion 60 of the present embodiment is configured by coupling flat wires in series. As illustrated in FIG. 2, the coil portion 60 is inserted into the plurality of slots S and routed in a wave shape. The coil portion 60 has a portion formed by wave-winding the slot S to one side in the circumferential direction and a portion formed by wave-winding the slot S to the other side in the circumferential direction. The portion wave-wound to one side in the circumferential direction and the portion wave-wound to the other side in the circumferential direction are connected by the connection bus bar unit 7.

As illustrated in FIG. 2, the connection bus bar unit 7 is disposed on one side in the axial direction of the first coil end 30e. The connection bus bar unit 7 extends along the circumferential direction of the central axis J. The connection bus bar unit 7 is fixed to and supported by the bus bar unit 5.

The connection bus bar unit 7 of the present embodiment includes a plurality of connection bus bars 15 that connect the conductive wires to each other at the radially inner end portion of the coil portion 60, and a connection bus bar holder 80 that holds the plurality of connection bus bars 15.

The bus bar unit 5 is disposed radially outside the first coil end 30e. The bus bar unit 5 is located directly above the first coil end 30e. The bus bar unit 5 extends along the circumferential direction of the central axis J. Therefore, the bus bar unit 5 extends in the circumferential direction along the outer periphery of the first coil end 30e on the upper side of the first coil end 30e. The bus bar unit 5 is disposed on one side in the axial direction of an end surface of the stator core 20 facing one side (+Y side) in the axial direction.

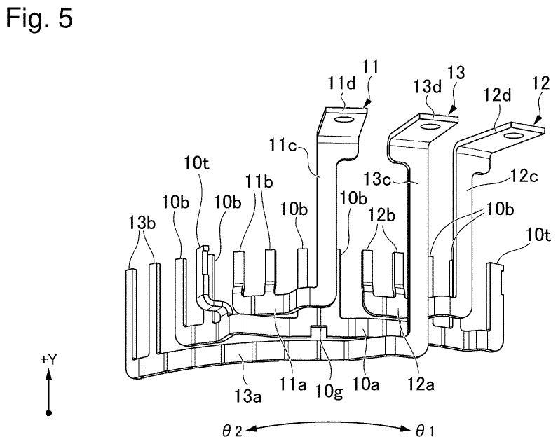

FIG. 4 is a perspective view of the bus bar unit 5. FIG. 5 is a perspective view of the neutral point bus bar 10 and the plurality of phase bus bars 11, 12, and 13.

As illustrated in FIG. 4, the bus bar unit 5 includes a plurality of bus bars 10, 11, 12, and 13, and a bus bar holder 90 that supports the bus bars 10, 11, 12, and 13. The plurality of bus bars 10, 11, 12, and 13 are connected to the stator 2 (see FIG. 1). The plurality of bus bars 10, 11, 12, and 13 are classified into the neutral point bus bar 10 and the three phase bus bars 11, 12, and 13.

As illustrated in FIG. 5, the neutral point bus bar 10 and the phase bus bars 11, 12, and 13 have a plate shape. The neutral point bus bar 10 and the phase bus bars 11, 12, and 13 are formed by press working. The neutral point bus bar 10 and the phase bus bars 11, 12, and 13 extend along the circumferential direction.

The neutral point bus bar 10 includes a neutral point bus bar main body 10a, a plurality of (six in the present embodiment) neutral point connection portions 10b, and a plurality of (two in the present embodiment) sensor attachment portions 10t.

The neutral point bus bar main body 10a extends in an arcuate shape centered on the central axis J when viewed from the axial direction. The neutral point bus bar main body 10a has the radial direction as the plate thickness direction.

The neutral point bus bar main body 10a is provided with a rectangular notch 10g that opens to the other side (−Y side) in the axial direction. The notch 10g extends from an edge on the other side (−Y side) in the axial direction of the neutral point bus bar main body 10a toward one side (+Y side) in the axial direction.

The neutral point connection portion 10b protrudes from the neutral point bus bar main body 10a to one side (+Y side) in the axial direction. The plurality of neutral point connection portions 10b are disposed on the same circumference centered on the central axis J. The neutral point connection portion 10b extends in the axial direction (Y-axis direction) with a uniform width. Shapes of all the neutral point connection portions 10b coincide with each other. Each neutral point connection portion 10b is connected to the second end 64 (see FIG. 3) extending radially outward from the first coil end 30e by a joining means such as welding.

The sensor attachment portion 10t protrudes from the neutral point connection portion 10b to one side (+Y side) in the axial direction. The sensor attachment portion 10t is bent and provided so as to be offset radially outward of the central axis J with respect to the neutral point connection portion 10b. As will be described later, the temperature sensor 8 is attached to the sensor attachment portion 10t.

The phase bus bars 11, 12, and 13 include phase bus bar main bodies 11a, 12a, and 13a, a plurality of (two in the present embodiment) phase connection portions 11b, 12b, and 13b, extending portions 11c, 12c, and 13c, and external connection terminals 11d, 12d, and 13d, respectively.

Among the three phase bus bars 11, 12, and 13 of the present embodiment, the U-phase bus bar 11 and the V-phase bus bar 12 have the same shape. As a result, the number of types of components can be reduced to achieve cost reduction. All of the three phase bus bars 11, 12, and 13 may have different shapes.

The phase bus bar main bodies 11a, 12a, and 13a extend along the circumferential direction. At least a part of each of the three phase bus bar main bodies 11a, 12a, and 13a overlaps the neutral point bus bar 10 radially outward or axially.

The phase bus bar main body 13a of the W-phase bus bar 13 is disposed on the other side (−Y side) in the axial direction of the neutral point bus bar main body 10a. The phase bus bar main body 13a is located on the opening side of the notch 10g of the neutral point bus bar main body 10a. That is, the phase bus bar main body 13a is disposed so as to cover the opening of the notch 10g.

In the phase bus bars 11, 12, and 13, the phase connection portions 11b, 12b, and 13b protrude to one side (+Y side) in the axial direction from the phase bus bar main bodies 11a, 12a, and 13a. The plurality of phase connection portions 11b, 12b, and 13b are disposed on the same circumference centered on the central axis J. The phase connection portions 11b, 12b, and 13b extend in the axial direction (Y-axis direction) with a uniform width. Shapes of all the phase connection portions 11b, 12b, and 13b coincide with each other. The phase connection portions 11b, 12b, and 13b have the same shape with the neutral point connection portion 10b. Each of the phase connection portions 11b, 12b, and 13b is joined with the first end 63 (see FIG. 3) extending radially outward from the first coil end 30e by joining means such as welding.

The extending portions 11c, 12c, and 13c of the phase bus bars 11, 12, and 13 extend from the end portions on the one circumferential direction side θ1 of the phase bus bar main bodies 11a, 12a, and 12c to the one axial side (+Y side).

The external connection terminals 11d, 12d, and 13d are disposed at the end portions on one side (+Y side) in the axial direction of the extending portions 11c, 12c, and 13c, respectively. The external connection terminals lid, 12d, and 13d extend along a plane orthogonal to the central axis J. External terminals (not illustrated) that apply U-phase, V-phase, and W-phase voltages are connected to the external connection terminals 11d, 12d, and 13d, respectively.

As illustrated in FIG. 4, the bus bar holder 90 embeds a part of the neutral point bus bar 10 and the plurality of phase bus bars 11, 12, and 13. Thus, the bus bar holder 90 holds the neutral point bus bar 10 and the phase bus bars 11, 12, and 13. The bus bar holder 90 is made of an insulating resin member. The bus bar holder 90 is molded by insert molding in which the neutral point bus bar 10 and the phase bus bars 11, 12, and 13 are embedded.

The bus bar holder 90 includes a holder body portion 91 and a plurality of (three in the present embodiment) props 92. The bus bar holder 90 is mounted on the core back 21 of the stator core 20. The bus bar holder 90 is fixed to, for example, the stator core 20.

The prop 92 extends upward from the holder body portion 91. The plurality of props 92 embed the extending portions 11c, 12c, and 13c of the phase bus bars 11, 12, and 13. Accordingly, the props 92 support the extending portions 11c, 12c, and 13c.

The holder body portion 91 embeds the neutral point bus bar main body 10a and the phase bus bar main bodies 11a, 12a, and 13a. The holder body portion 91 exposes the sensor attachment portion 10t, the neutral point connection portion 10b, and the phase connection portions 11b, 12b, and 13b from the end surface on one side (+Y side) in the axial direction. That is, the sensor attachment portion 10t, the neutral point connection portion 10b, and the phase connection portions 11b, 12b, and 13b protrude to one side (+Y side) in the axial direction with respect to the holder body portion 91.

The holder body portion 91 is provided with an open portion 91a that exposes a part of the neutral point bus bar main body 10a in the up-down direction. The open portion 91a has a rectangular shape when viewed from above. The notch 10g is provided in a portion exposed by the open portion 91a of the neutral point bus bar main body 10a. The bus bar unit 5 penetrates the inside of the notch 10g in the radial direction. Here, a region surrounded by the notch 10g and the open portion 91a is referred to as a first opening portion (opening portion) 5h.

The holder body portion 91 is provided with a holder notch 91p recessed downward from the upper end edge. The holder notch 91p of the present embodiment is disposed between the phase connection portion 13b and the neutral point connection portion 10b in the circumferential direction. That is, the bus bar unit 5 opens in the radial direction inside the holder notch 91p. Here, a region inside the holder notch 91p is referred to as a second opening portion (opening portion) 5k.

The bus bar unit 5 has two opening portions 5h and 5k that open radially inward and outward. The opening portions 5h and 5k include the first opening portion 5h and the second opening portion 5k. The first opening portion 5h and the second opening portion 5k are arranged in the circumferential direction of the central axis J.

In the present embodiment, a case where the bus bar unit 5 is provided with the two opening portions 5h and 5k will be described, but the number of opening portions is not limited thereto. At least one opening portion may be provided, and three or more opening portions may be provided.

As illustrated in FIG. 4, two temperature sensors 8 are attached to the bus bar unit 5. The temperature sensor 8 is attached to the sensor attachment portion 10t of the neutral point bus bar 10. The temperature sensor 8 has a wire 8c extending to a control device (not illustrated).

The sensor attachment portion 10t of the neutral point bus bar 10 is exposed from the bus bar holder 90. The temperature sensor 8 is in direct contact with the neutral point bus bar 10 at the sensor attachment portion 10t, and measures the temperature of the neutral point bus bar 10.

In the following description, one of the two temperature sensors 8 disposed on one circumferential direction side θ1 is referred to as a first temperature sensor 8a, and the other disposed on the other circumferential direction side is referred to as a second temperature sensor 8b. Similarly, in the following description, the sensor attachment portion 10t to which the first temperature sensor 8a is attached is referred to as a first sensor attachment portion 10ta, and the sensor attachment portion 10t to which the second temperature sensor 8b is attached is referred to as a second sensor attachment portion 10tb.

In the present embodiment, a case where the temperature sensor 8 is attached to the neutral point bus bar 10 will be described. However, the temperature sensor 8 may be attached to any of the phase bus bars 11, 12, and 13. That is, at least one of the plurality of bus bars 10, 11, 12, and 13 only needs to have the sensor attachment portion 10t.

As illustrated in FIG. 1, the fluid feed portion 95 has a pipe shape extending along the axial direction of the central axis J. The fluid feed portion 95 is disposed inside the housing 4. The fluid feed portion 95 is located radially outside the stator 2 and directly above the stator 2. The fluid O flows from the end portion on the other side (−Y side) in the axial direction toward one side (+Y side) in the axial direction to the fluid feed portion 95. The flow of the fluid O in the fluid feed portion 95 may be in a direction opposite to the present embodiment.

In this specification, “directly above” means that they are disposed so as to overlap each other when viewed from above and the up-down direction.

The end portion on the other side (−Y side) in the axial direction of the fluid feed portion 95 is connected to the flow path 9. The flow path 9 sucks up the fluid O accumulated in the housing 4 and sends the fluid O to the fluid feed portion 95. A pump and a cooler (not illustrated) are disposed in the path of the flow path 9. The pump pressure-feeds the fluid O in the flow path 9. On the other hand, the cooler cools the fluid in the flow path 9.

The fluid feed portion 95 is provided with a plurality of feed holes 96, 97, and 98 for feeding the fluid O to the stator 2. The plurality of feed holes 96, 97, and 98 are arranged along the axial direction. The plurality of feed holes 96, 97, and 98 are holes penetrating in the thickness direction of the pipe constituting the fluid feed portion 95. The openings of the feed holes 96, 97, and 98 face the stator 2 side. Among the plurality of feed holes 96, 97, and 98, some feed holes 96 are disposed directly above the first coil end 30e, some other feed holes 97 are disposed directly above the second coil end 30f, and the other feed holes 98 are disposed directly above the stator core 20.

The bus bar unit 5 is disposed between the feed hole 96 disposed directly above the first coil end 30e and the first coil end 30e. The feed hole 96 allows the fluid O of the first coil end 30e to pass through the bus bar unit 5. Therefore, the fluid O fed from the feed hole 96 cools not only the first coil end 30e but also the bus bar unit 5.

The feed hole 97 disposed directly above the second coil end 30f feeds the fluid O to the second coil end 30f. Further, the feed hole 98 disposed directly above the stator core 20 feeds the fluid O to the outer peripheral surface of the stator core 20.

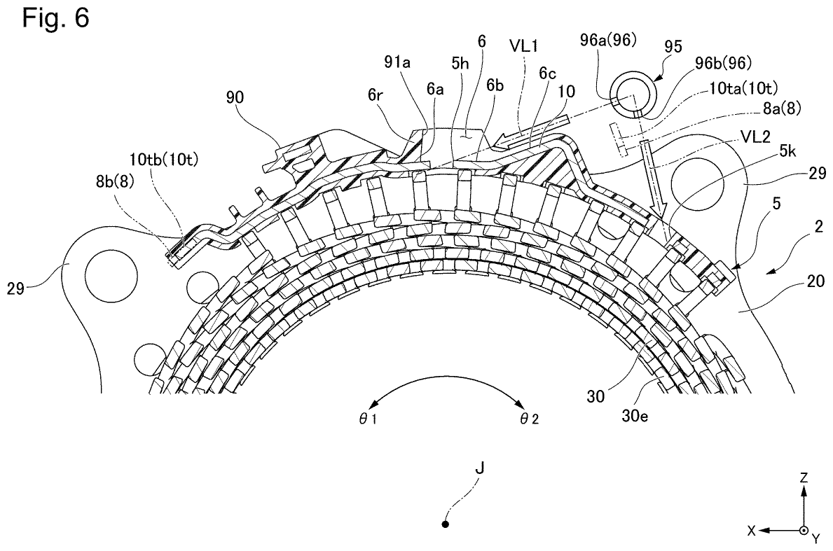

FIG. 6 is a cross-sectional view of the fluid feed portion 95, the bus bar unit 5, and the stator 2 of the present embodiment.

The fluid feed portion 95 is disposed directly above the bus bar unit 5 at least partially. Two feed holes 96 are provided in a portion of the fluid feed portion 95 located directly above the bus bar unit 5. In the following description, one of the two feed holes 96 is referred to as a first feed hole 96a, and the other is referred to as a second feed hole 96b. That is, the feed hole 96 includes the first feed hole 96a and the second feed hole 96b.

The first opening portion 5h and the second opening portion 5k of the bus bar unit 5 are disposed side by side along the circumferential direction. As described above, the first opening portion 5h and the second opening portion 5k open in the radial direction of the central axis J. That is, the first opening portion 5h and the second opening portion 5k open toward the stator 2. In the present embodiment, the bus bar unit 5 is disposed above the stator 2. Therefore, the first opening portion 5h and the second opening portion 5k open to the upper side and the lower side.

The first opening portion 5h is disposed in the opening direction of the first feed hole 96a. Therefore, at least a part of the fluid O ejected from the first feed hole 96a reaches the first opening portion 5h. As described above, since the first opening portion 5h opens toward the stator 2, the fluid O reaching the first opening portion 5h is fed to the stator 2.

The first opening portion 5h of the present embodiment is disposed directly above the central axis J. Since the outer periphery of the stator 2 extends in an arc shape around the central axis J, the outer periphery has the highest height directly above the central axis J. The fluid O dropped downward from the first opening portion 5h is fed to the highest portion of the stator 2 and flows to both sides of the stator 2 in the circumferential direction.

The second opening portion 5k is disposed in the opening direction of the second feed hole 96b. Therefore, at least a part of the fluid O ejected from the second feed hole 96b reaches the second opening portion 5k. The fluid O that has reached the second opening portion 5k is fed to the stator 2.

According to the present embodiment, since the first opening portion 5h and the second opening portion 5k open to the stator 2 side, the fluid O fed from the fluid feed portion 95 to the stator 2 side can pass therethrough. As a result, not only the stator 2 but also the bus bar unit 5 can be cooled by the fluid O. When the neutral point bus bar 10 and the phase bus bars 11, 12, and 13 of the bus bar unit 5 are heated to a high temperature by heat transferred from the winding portion 30 or Joule heat, the electric resistance value increases. By cooling the bus bar unit 5, the electric resistance values of the neutral point bus bar 10 and the phase bus bars 11, 12, and 13 can be reduced, and the driving efficiency of the drive apparatus 1 can be enhanced.

In the present embodiment, the bus bar unit 5 extends in the circumferential direction along the outer periphery of the stator 2. Therefore, when the fluid O is ejected from the feed hole 96 in the circumferential direction, the fluid O scattered by the bus bar unit 5 extending in the circumferential direction can be received to cool the bus bar unit 5 as a whole. As a result, the cooling efficiency of the bus bar unit 5 can be enhanced by effectively utilizing the fluid O.

According to the present embodiment, since the bus bar unit 5 extends in the circumferential direction, the fluid O fed from the feed hole 96 to the bus bar unit 5 is easily guided to the first opening portion 5h or the second opening portion 5k along the circumferential direction. The fluid O takes heat from the bus bar unit 5 in the process of being guided in the circumferential direction by the bus bar unit 5, and can efficiently cool the bus bar unit 5.

According to the present embodiment, since the first opening portion 5h and the second opening portion 5k are provided in the bus bar unit 5, the fluid O can be intensively fed immediately below the first opening portion 5h and the second opening portion 5k. As described above, since the first opening portion 5h is disposed directly above the central axis J, the fluid O passing through the first opening portion 5h is fed to the highest position of the stator 2 (more specifically, the first coil end 30e). The fluid O fed from the first opening portion 5h to the stator 2 flows substantially uniformly on both circumferential sides of the first coil end 30e to efficiently cool the stator 2 along the circumferential direction.

The bus bar unit 5 of the present embodiment includes a connection flow path 6 that connects the first feed hole 96a and the first opening portion 5h. The connection flow path 6 of the present embodiment is recessed radially inward of the central axis J and vertically downward. The connection flow path 6 of the present embodiment extends in a groove shape along a direction orthogonal to the axial direction of the central axis J on the radially outer surface of the bus bar unit 5. More specifically, the connection flow path 6 has a groove shape that opens radially outward and extends along the circumferential direction. The connection flow path 6 guides the fluid O ejected from the first feed hole 96a to the first opening portion 5h.

The connection flow path 6 has a wall portion 6a and a bottom portion 6b. The wall portion 6a extends upward from the bottom portion 6b. The wall portion 6a surrounds the bottom portion 6b. The wall portion 6a is an inner surface of the open portion 91a of the bus bar holder 90. The bottom portion 6b faces upward. The bottom portion 6b is provided with the first opening portion 5h. The bottom portion 6b of the present embodiment is a surface of the neutral point bus bar 10 exposed by the open portion 91a.

According to the present embodiment, the bus bar unit 5 includes the connection flow path 6. Therefore, the bus bar unit 5 receives the fluid O ejected from the first feed hole 96a and guides the fluid O to the first opening portion 5h in a wide region where the connection flow path 6 is provided. According to the present embodiment, since more fluid O can be guided to the first opening portion 5h and the fluid O can be fed to a desired position of the stator 2, the cooling efficiency of the stator 2 can be enhanced.

The connection flow path 6 of the present embodiment extends in a groove shape along a direction orthogonal to the axial direction on the radially outer surface of the bus bar unit 5. The connection flow path of the present embodiment can cause the fluid O to flow along a direction (circumferential direction in the present embodiment) orthogonal to the axial direction. As a result, the fluid O ejected from the first feed hole 96a in the direction orthogonal to the axial direction can be efficiently received by the connection flow path 6. In the process of guiding the fluid O to the first opening portion 5h by the groove-shaped connection flow path 6, the wall portion 6a and the bottom portion 6b of the connection flow path 6 can be cooled, and the bus bar unit 5 can be efficiently cooled.

The connection flow path 6 of the present embodiment is recessed vertically downward in a recessed shape. Therefore, the connection flow path 6 can store the fluid O. The connection flow path 6 of the present embodiment temporarily stores the fluid O when the feed amount of the fluid O from the first feed hole 96a to the connection flow path 6 is larger than the flow rate of the fluid that can be dropped from the first opening portion 5h. As a result, even after the feeding of the fluid O from the feed hole 96 is stopped, the fluid O can be continuously fed from the bus bar unit 5 toward the stator 2 for a long time. That is, even after the drive apparatus 1 is stopped, the cooling of the stator 2 for restart can be continued. In addition, by storing the fluid O in the fluid feed portion 95, the bus bar unit 5 can be cooled by the stored fluid O.

The neutral point bus bar 10 is exposed at the bottom portion 6b of the connection flow path 6 of the present embodiment. Therefore, the fluid O comes into contact with the neutral point bus bar 10 in the process of flowing through the connection flow path 6. According to the present embodiment, the neutral point bus bar 10 can be directly cooled by the fluid O.

As illustrated in FIG. 4, a portion of the wall portion 6a surrounding the first opening portion 5h is defined as a first side wall 6p, a second side wall 6q, and a third side wall 6r. The first side wall 6p is disposed on one side (+Y side) in the axial direction of the first opening portion 5h. The second side wall 6q is disposed on the other side (−Y side) in the axial direction of the first opening portion 5h and faces the first side wall 6p. The third side wall 6r is disposed on one side in the circumferential direction of the first opening portion 5h and connects the first side wall 6p and the second side wall 6q.

The first side wall 6p is configured by an end surface facing the other side (−Y side) in the axial direction of the prop 92 of the bus bar holder 90. The extending portion 11c of the U-phase bus bar 11 is embedded inside the prop 92. According to the present embodiment, the U-phase bus bar 11 can be cooled by the fluid O accumulated in the connection flow path 6.

The second side wall 6q protrudes radially outward with respect to the outer peripheral surface of the bus bar holder 90. Two ribs 91c are provided on the surface on the other side (−Y side) in the axial direction of the second side wall 6q. The rib 91c reinforces the second side wall 6q.

As illustrated in FIG. 6, the third side wall 6r is disposed to face the opening direction of the first feed hole 96a. According to the present embodiment, the fluid O ejected from the first feed hole 96a is received, and scattering of the fluid O from the connection flow path 6 is suppressed. As a result, more fluid can be guided to the first opening portion 5h.

The bottom portion 6b is provided with an inclination portion 6c that is inclined vertically downward from the first feed hole 96a toward the first opening portion 5h. The inclination portion 6c faces the third side wall 6r in the circumferential direction. The connection flow path 6 is recessed downward in a region surrounded by the wall portion 6a (that is, the first side wall 6p, the second side wall 6q, and the third side wall 6r illustrated in FIG. 4) and the inclination portion 6c, and stores the fluid O.

According to the present embodiment, since the inclination portion 6c inclined vertically downward toward the first opening portion 5h is provided in the bottom portion 6b of the connection flow path 6, the fluid O accumulated in the connection flow path 6 can be guided to the first opening portion 5h side. As a result, it is possible to suppress the fluid O from staying in the connection flow path 6.

As illustrated in FIG. 6, when viewed from the axial direction of the central axis J, a straight line connecting the first feed hole 96a and the first opening portion 5h is defined as a first virtual line VL1, and a straight line connecting the second feed hole 96b and the second opening portion 5k is defined as a second virtual line VL2. Since the first feed hole 96a ejects the fluid O along the first virtual line VL1, the fluid O can be efficiently guided to the first opening portion 5h. Similarly, since the second feed hole 96b ejects the fluid O along the second virtual line VL2, the fluid O can be efficiently guided to the second opening portion 5k.

The first sensor attachment portion 10ta and the first temperature sensor 8a of the present embodiment are disposed immediately below the fluid feed portion 95. A second temperature sensor attachment portion 10tb and the second temperature sensor 8b of the present embodiment are provided at positions different from the first virtual line VL1 and the second virtual line VL2 without overlapping the first virtual line VL1 and the second virtual line VL2 when viewed from the axial direction.

According to the present embodiment, the first temperature sensor 8a and the second temperature sensor 8b are not disposed in the ejection path of the fluid O ejected from the first feed hole 96a and the second feed hole 96b, and are not directly cooled by the fluid O. As a result, the temperature sensor 8 can be prevented from measuring the temperature of the fluid O, and the temperature of the bus bar unit 5 can be accurately measured.

The first sensor attachment portion 10ta and the first temperature sensor 8a of the present embodiment are disposed between the first virtual line VL1 and the second virtual line (VL2) when viewed from the axial direction. The first temperature sensor 8a measures the temperature of the bus bar unit 5 between a portion cooled by the fluid O fed from the first feed hole 96a and a portion cooled by the fluid O fed from the second feed hole 96b. As a result, the first temperature sensor 8a can measure the temperature of the bus bar unit 5 reflecting the cooling by the fluid O, and can observe the cooling efficiency by the feeding of the fluid O over time.

The first sensor attachment portion 10ta and the first temperature sensor 8a of the present embodiment are located between the fixing portions 29 adjacent to each other in the circumferential direction when viewed from the axial direction. According to the present embodiment, it is possible to suppress interference between the temperature sensor 8 and the fixing portion 29 at the time of the assembly process of the drive apparatus 1, and to provide the drive apparatus 1 with high reliability.

Next, a configuration of an opening portion according to a modification that can be employed in the above-described embodiment will be described. The opening portion of each modification can be adopted instead of the first opening portion 5h or the second opening portion 5k of the above-described embodiment.

Note that, in the description of each modification described below, the same reference numerals are given to the same components as those of the embodiment and the modification described above, and the description thereof will be omitted.

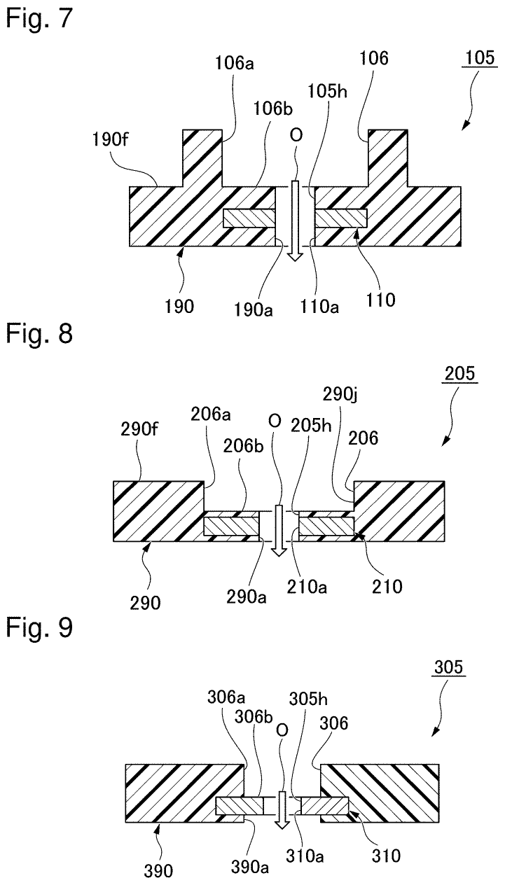

FIG. 7 is a schematic cross-sectional view of the vicinity of an opening portion 105h of a bus bar unit 105 of Modification 1.

The bus bar unit 105 of the present modification includes a bus bar 110 and a bus bar holder 190 in which the bus bar 110 is embedded. The bus bar 110 has a first through hole 110a, and the bus bar holder 190 has a second through hole 190a. The first through hole 110a and the second through hole 190a overlap each other when viewed from the thickness direction of the bus bar unit 105.

The first through hole 110a and the second through hole 190a constitute the opening portion 105h. That is, the bus bar unit 105 has the opening portion 105h. The opening portion 105h of the present modification is provided in a portion where the bus bar 110 and the bus bar holder 190 overlap. Therefore, the bus bar 110 and the bus bar holder 190 are exposed on the inner surface of the opening portion 105h. According to the present modification, the bus bar 110 and the bus bar holder 190 can be directly cooled by the fluid O passing through the opening portion 105h.

The bus bar holder 190 includes a connection flow path 106 that connects the feed hole 96 (see FIG. 6) and the opening portion 105h. Since the connection flow path 106 is recessed vertically downward, the fluid O can be stored. The connection flow path 106 has a bottom portion 106b and a wall portion 106a. The bottom portion 106b is provided with the opening portion 105h. The wall portion 106a surrounds the opening portion 105h.

The bottom portion 106b and the wall portion 106a are a part of the surface of the bus bar holder 190. The wall portion 106a protrudes from an outer peripheral surface 190f of the bus bar holder 190. According to the present modification, the shape, height, and the like of the wall portion 106a can be configured relatively freely.

FIG. 8 is a schematic cross-sectional view of the vicinity of an opening portion 205h of a bus bar unit 205 of Modification 2.

The bus bar unit 205 of the present modification includes a bus bar 210 and a bus bar holder 290 in which the bus bar 210 is embedded. The bus bar 210 has a first through hole 210a, and the bus bar holder 290 has a second through hole 290a. The first through hole 210a and the second through hole 290a overlap each other when viewed from the thickness direction of the bus bar unit 205.

The first through hole 210a and the second through hole 290a constitute an opening portion 205h. That is, the bus bar unit 205 has the opening portion 205h. The opening portion 205h of the present modification is provided in a portion where the bus bar 210 and the bus bar holder 290 overlap. Therefore, the bus bar 210 and the bus bar holder 290 are exposed on the inner surface of the opening portion 205h. According to the present modification, the bus bar 210 and the bus bar holder 290 can be directly cooled by the fluid O passing through the opening portion 205h.

The bus bar holder 290 includes a connection flow path 206 that connects the feed hole 96 (see FIG. 6) and the opening portion 205h. Since the connection flow path 206 is recessed vertically downward, the fluid O can be stored. The connection flow path 206 has a bottom portion 206b and a wall portion 206a. The bottom portion 206b is provided with the opening portion 205h. The wall portion 206a surrounds the opening portion 205h.

The bottom portion 206b and the wall portion 206a are a part of the surface of the bus bar holder 290. The wall portion 206a is an inner surface of a recess 290j recessed downward with respect to the outer peripheral surface 290f of the bus bar holder 290. According to the present embodiment, since the wall portion 206a does not protrude from the outer peripheral surface 290f of the bus bar unit 205, it is easy to reduce the thickness of the bus bar unit 205.

FIG. 9 is a schematic cross-sectional view of the vicinity of an opening portion 305h of a bus bar unit 305 of Modification 3.

The bus bar unit 305 of the present modification includes a bus bar 310 and a bus bar holder 390 in which the bus bar 310 is embedded. The bus bar 310 has a first through hole 310a, and the bus bar holder 390 has a second through hole 390a.

The bus bar 310 of the present modification protrudes inward from the inner surface of the second through hole 390a of the bus bar holder 390. The first through hole 310a and the second through hole 390a overlap each other when viewed from the thickness direction of the bus bar unit 305. Therefore, the first through hole 310a is included inside the second through hole 390a when viewed from the thickness direction of the bus bar unit 305.

The first through hole 310a constitutes the opening portion 305h. That is, the bus bar unit 305 has the opening portion 305h. The opening portion 305h of the present modification is provided in a portion where the bus bar holder 390 is not disposed but the bus bar 310 is disposed. Therefore, only the bus bar 310 is exposed on the inner surface of the opening portion 305h. According to the present modification, the fluid O passing through the opening portion 305h effectively cools the bus bar 310.

The bus bar holder 390 includes a connection flow path 306 that connects the feed hole 96 (see FIG. 6) and the opening portion 305h. Since the connection flow path 306 is recessed vertically downward, the fluid O can be stored. The connection flow path 306 has a bottom portion 306b and a wall portion 306a. The bottom portion 306b is provided with the opening portion 305h. The wall portion 306a surrounds the opening portion 305h.

The bottom portion 306b of the present modification is a part of the surface of the bus bar 310. On the other hand, the wall portion 306a of the present modification is a part of the surface of the bus bar holder 390 and is an inner surface of the second through hole 390a. According to the present modification, the bus bar 310 can be directly cooled by the fluid O accumulated in the connection flow path 306.

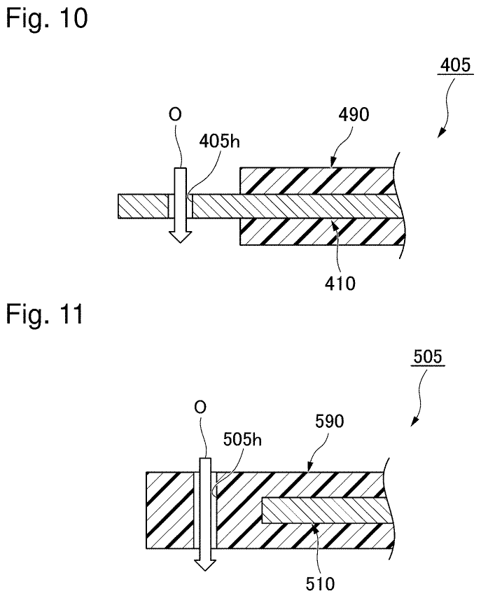

FIG. 10 is a schematic cross-sectional view of the vicinity of an opening portion 405h of a bus bar unit 405 of Modification 4.

The bus bar unit 405 of the present modification includes a bus bar 410 and a bus bar holder 490 in which the bus bar 410 is embedded. The bus bar 410 protrudes from the outer edge of the bus bar holder 490 and is exposed. The bus bar 410 has the opening portion 405h in a portion exposed from the bus bar holder 490. That is, the bus bar unit 405 has the opening portion 405h.

The opening portion 405h of the present modification is provided in a portion where the bus bar holder 490 is not disposed but the bus bar 410 is disposed. Therefore, only the bus bar 410 is exposed on the inner surface of the opening portion 405h. According to the present modification, the fluid O passing through the opening portion 405h effectively cools the bus bar 410.

FIG. 11 is a schematic cross-sectional view of the vicinity of an opening portion 505h of a bus bar unit 505 of Modification 5.

The bus bar unit 505 of the present modification includes a bus bar 510 and a bus bar holder 590 in which the bus bar 510 is embedded. The bus bar holder 590 has the opening portion 505h in a portion protruding with respect to the outer edge of the bus bar 510. That is, the bus bar unit 505 has the opening portion 505h.

The opening portion 505h of the present modification is provided in a portion where the bus bar 510 is not disposed but the bus bar holder 590 is disposed. Therefore, only the bus bar holder 590 is exposed on the inner surface of the opening portion 505h. According to the present modification, since the opening portion 505h is configured by the bus bar holder 590, the shape of the opening portion 505h can be configured relatively freely.

Although the embodiment of the present invention and the modification thereof have been described above, the respective configurations and combinations thereof in the embodiment and the modification are merely examples, and therefore addition, omission, substation and other variations of the configurations can be made within the scope not departing from the gist of the present invention. Also note that the present invention is not limited by the embodiment.

For example, in the above-described embodiment, the case where the fluid feed portion has a pipe shape has been described. However, the fluid feed portion only needs to be configured to be able to feed the fluid toward the stator, and may be, for example, a gutter provided with a feed hole at the bottom portion.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive apparatus comprising:
a rotor having a shaft that rotates about a central axis;
a stator disposed radially outside the rotor;
a bus bar unit having a plurality of bus bars connected to the stator and a bus bar holder supporting the bus bars;
a fluid feed portion disposed radially outside the stator and provided with a feed hole for feeding a fluid to the stator; and
a housing that accommodates the rotor, the stator, the bus bar unit, and the fluid feed portion,
wherein the bus bar unit has an opening portion that extends along a circumferential direction along an outer periphery of the stator and opens toward the stator.

2. The drive apparatus according to claim 1, wherein the bus bar unit includes a connection flow path connecting the feed hole and the opening portion.

3. The drive apparatus according to claim 2, wherein
the connection flow path extends in a groove shape along a direction orthogonal to an axial direction on a radially outer surface of the bus bar unit, and
the connection flow path includes a wall portion and a bottom portion provided with the opening portion.

4. The drive apparatus according to claim 2, wherein
the connection flow path is recessed vertically downward in a recessed shape when viewed from an axial direction, and
the connection flow path includes a wall portion and a bottom portion provided with the opening portion.

5. The drive apparatus according to claim 2, wherein
the feed hole is disposed vertically above the opening portion, and
a bottom portion of the connection flow path is provided with an inclination portion that is inclined vertically downward from the feed hole toward the opening portion.

6. The drive apparatus according to claim 1, comprising: temperature sensor,
wherein
the feed hole includes a first feed hole and a second feed hole,
the opening portion includes a first opening portion and a second opening portion,
at least one of the plurality of bus bars includes a sensor attachment portion to which the temperature sensor is fixed, and
the sensor attachment portion is disposed between a first virtual line connecting the first feed hole and the first opening portion and a second virtual line connecting the second feed hole and the second opening portion when viewed from an axial direction.

7. The drive apparatus according to claim 6, wherein
the stator includes:
an annular stator core centered on a central axis; and
a winding portion mounted on the stator core,
the stator core includes a plurality of fixing portions that protrude radially outward and are fixed to the housing, and
the sensor attachment portion is located between the fixing portions adjacent to each other in a circumferential direction when viewed from an axial direction.

8. The drive apparatus according to claim 1, wherein the opening portion is provided in a portion where the bus bar and the bus bar holder overlap.

9. The drive apparatus according to claim 1, wherein the opening portion is provided in a portion where the bus bar holder is not disposed but the bus bar is disposed.

10. The drive apparatus according to claim 1, wherein the opening portion is provided in a portion where the bus bar is not disposed but the bus bar holder is disposed.
